(19) United States
(12) Patent Application Publication
(10) Pub. No.: US 2008/0029560 A1
(43) Pub. Date: Feb. 7, 2008

(54) Mobile seed spreader

(76) Inventors: Kevin J. Pierce, Grand Forks, ND (US); Michael J. Pierce, Grand Forks, ND (US); Randy Dufault, East Grand Forks, MN (US)

Correspondence Address: ROBERT E. KLEVE, 1103-24TH AVE S., GRAND FORKS, ND, 58201, US

(21) Appl. No.: 11/493,201

(22) Filed: Jul. 26, 2006

(51) Int. Cl. A01C 15/18

(52) U.S. Cl. 222/622

(57) ABSTRACT

The invention comprises of a two wheeled seed spreader having a centrally located box for storing the seed. The box has surrounding sides and an open bottom. A conveyor belt is mounted across the open bottom for conveying seed in the box forward to the front bottom of the box, an adjustable brush is mounted above the forward end of the conveyor and adjustable downward against the belt to vary the amount of seed conveyed off the forward end of the belt. A rotary brush is mounted just in front of the forward end of the belt and driven counterclockwise and downward against the belt to drive seed traveling off the forward end of the belt downward toward the ground.

This invention relates to a trailer for dispensing peat moss on golf courses and the like. It is an object of the invention to provide a novel dispensing trailer for feeding peat moss evenly onto golf courses and the like. It is another object of the invention to provide a 2-wheeled hopper having a roller for feeding peat moss onto surfaces. Further objects and advantages of the invention will become apparent as the description proceeds and when taken in conjunction with the accompanying drawings wherein:

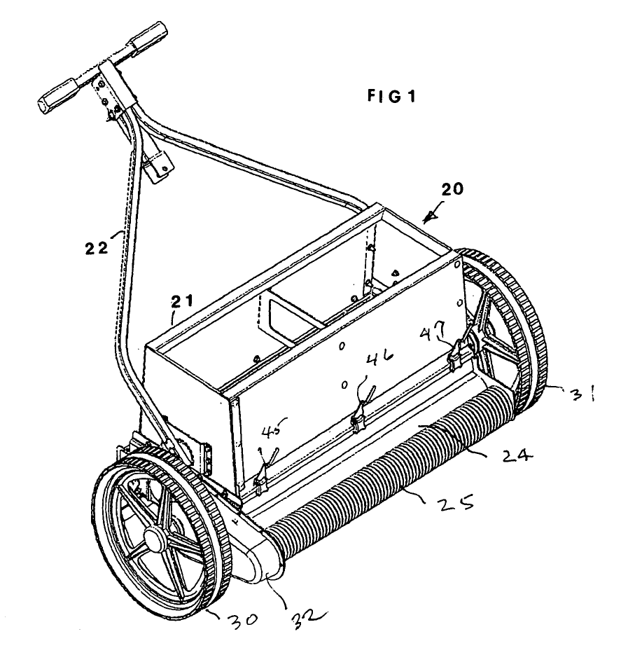

FIG. 1 is perspective view of the 2-wheeled hopper or trailer.

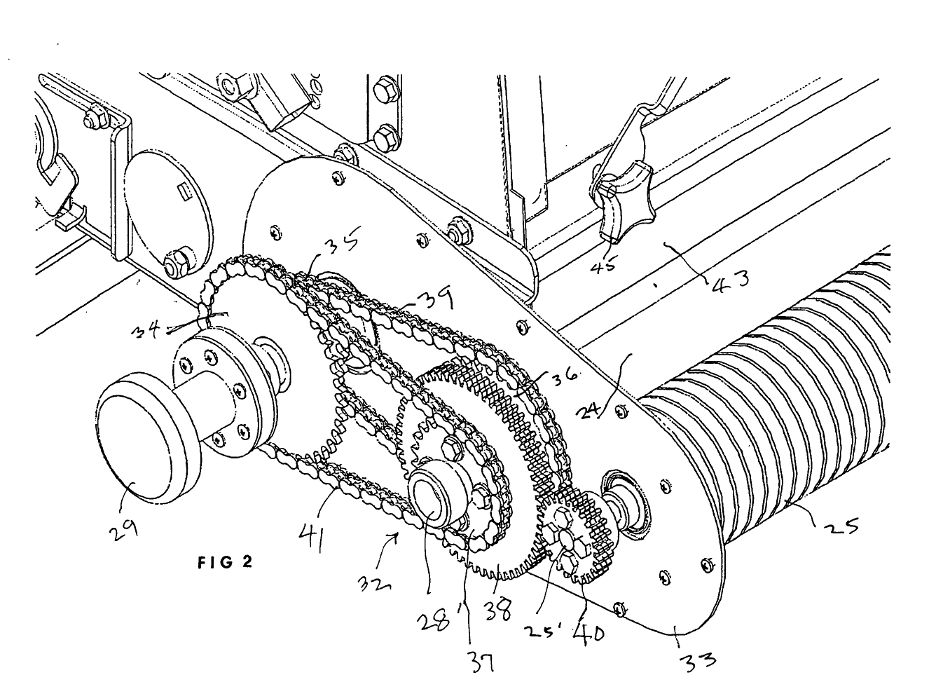

FIG. 2 is an enlarged perspective view of the gear drive for the trailer with the gear housing and wheel cut away so as to reveal the gear drive to the conveyor belt and brush.

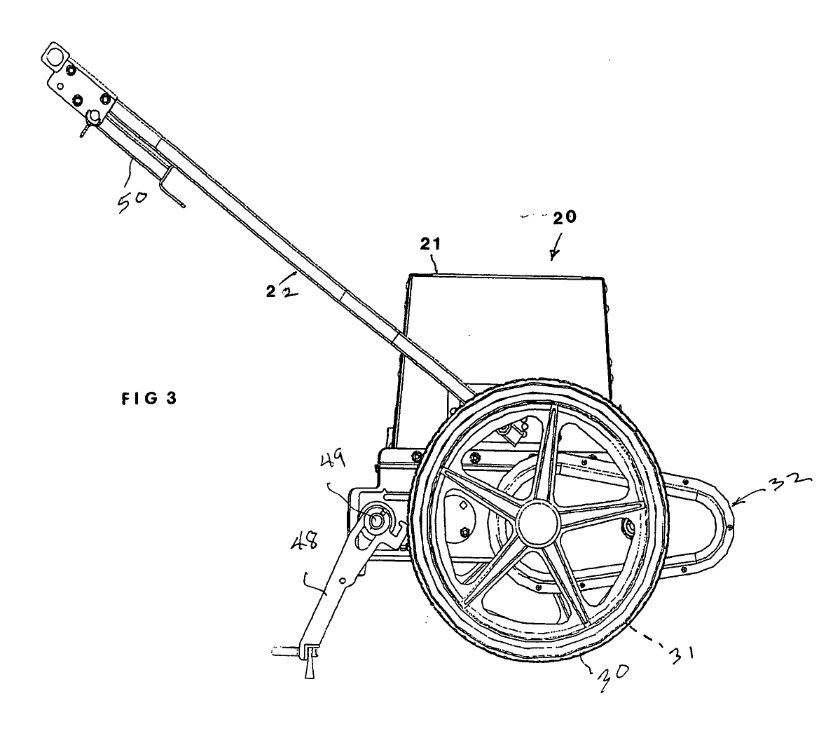

FIG. 3 is a side elevational view of the peat moss dispensing trailer.

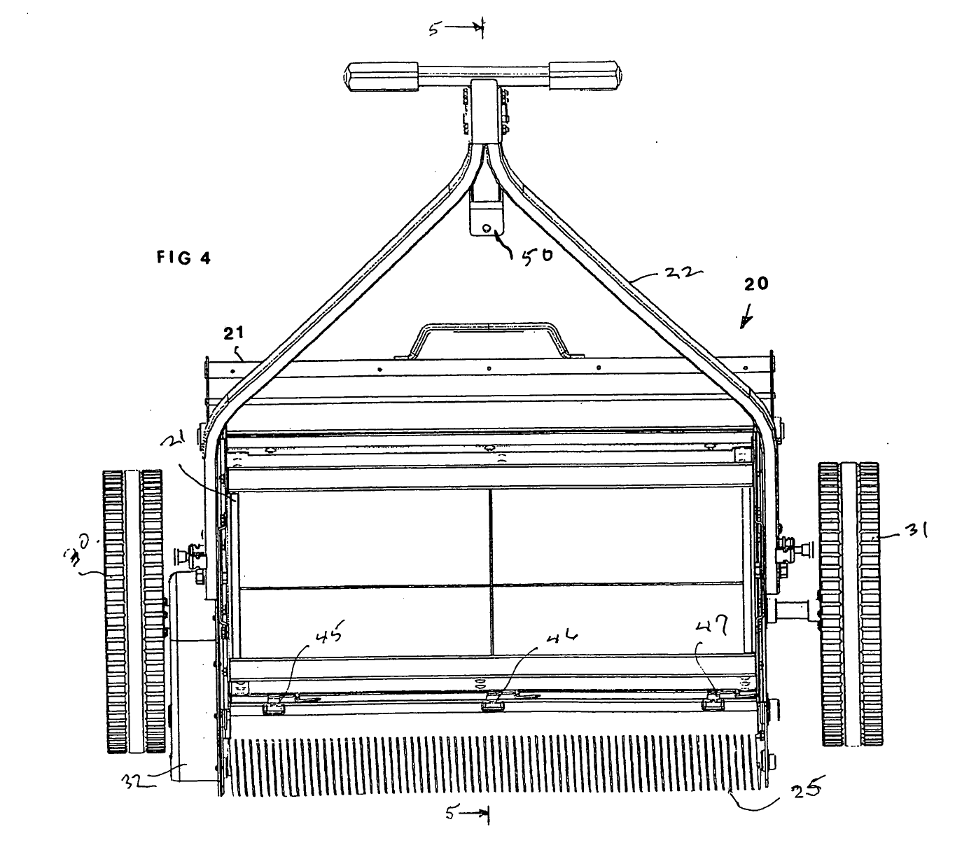

FIG. 4 is a top view of the trailer.

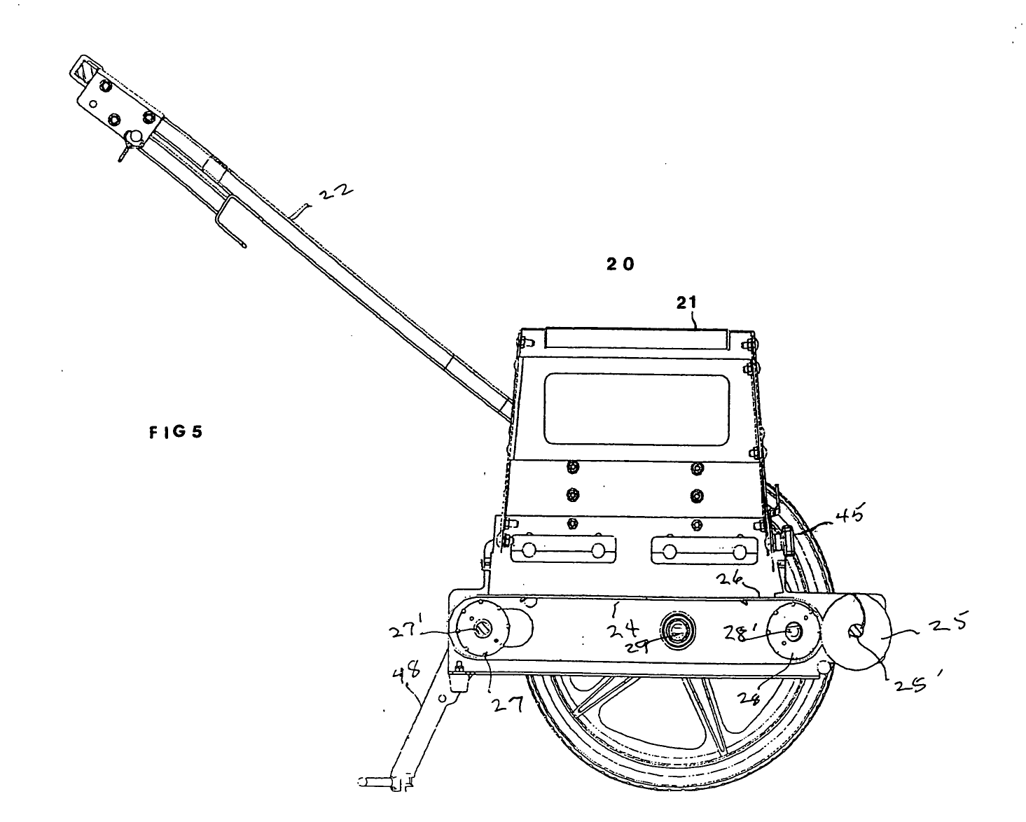

FIG. 5 is a cross sectional view of the trailer taken along line 5-5 of FIG. 4.

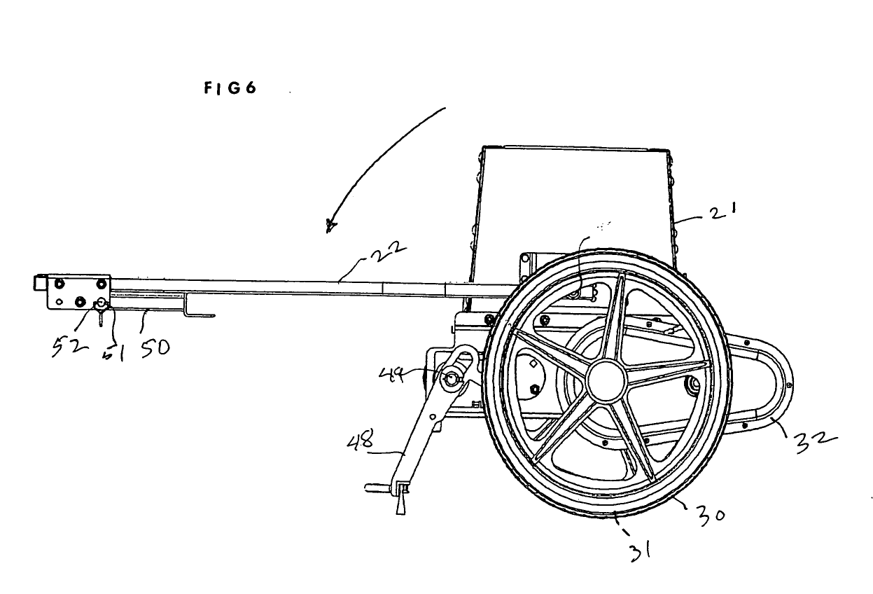

FIG. 6 illustrates the handle being lowered to its horizontal position for towing.

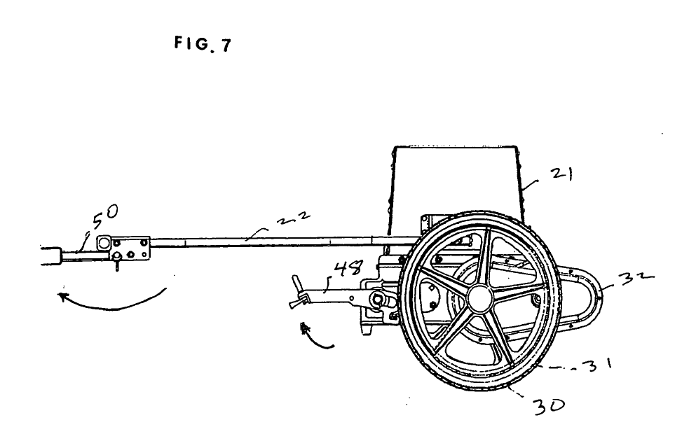

FIG. 7 illustrated the apparatus with the handle in its horizontal position and with the hitch rotated 180 degrees clockwise to place the hitch in an operative position for towing and with the drag brush pivoted up in its inoperative position.

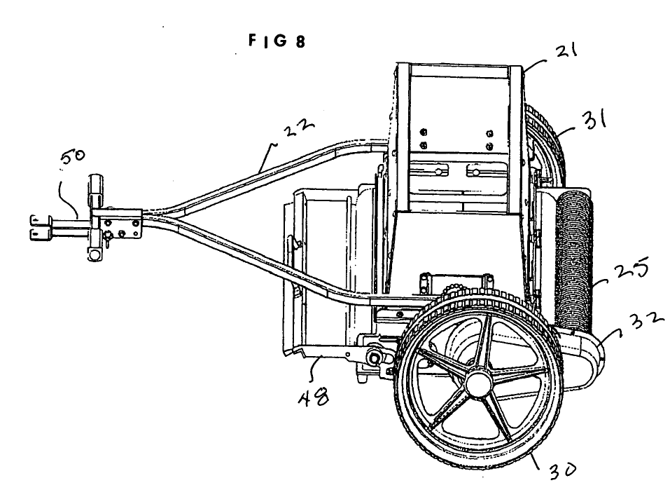

FIG. 8 is an enlarged frontal view of one of the caming levers with the handle cut away to better illustrate the caming of the brush down against the conveying belt.

Referring more particularly to the drawings, in FIG. 1 the moss dispensing trailer 20 is illustrated having a hopper 21. A handle 22 is pivotally mounted to the hopper 21. The hopper is formed of our inclined side panels 23, 23′, 23″, and 23′″. The front and rear side panels 23 and 23′ are slanted towards one another at their tops so as to form surfaces that tend to will not allow the moss accumulate or cling on these sides, but rather will tend to drop off the sides as the peat moss is emptied out of the hopper.

The hopper has an endless circular conveyor belt 24 mounted across the bottom of the hopper and a brush 25 has center shaft 25′ and the brush is fixed to the shaft 25′. The shaft 25′ is rotatably mounted to the bottom front 26 of the hopper in front of the conveyor belt. The conveyor belt is an endless belt with rollers 27 and 28 are fixed to shafts 27′ and 28′, respectively. The shafts 27′ and 28′ rotatably mounted to the bottom of the hopper, so that the belt may be rotated to feed peat moss on the inside of the hopper, and the like, toward the front bottom of the hopper. A shaft 29 is rotatably mounted to the bottom of the hopper and a pair of wheels 30 and 31 are fixed to the ends of the shaft on each side of the hopper. The wheels rotatably support the hopper on the ground as the hopper is rolled along the ground.

A gear drive 32 is mounted to the outside of the right side of the hopper in a housing 33. A large 34 and a small gear 35 are fixed to the shaft 29 so that rotation of the wheels on the ground by the operator pushing the hopper forward on the ground by the handle 22 will rotate the wheels which will rotate the shaft 29, which in turn will rotate the gears 34 and 35. Three gears 36, 37, and 38 are mounted to the front shaft 28′ of the belt. The gear 36 is fixed to the front shaft 28′ of the conveyor belt and a chain 39 connects the gear 35 to the gear 36 so that rotation of the gear 36 through the chain connection drives gear 36. Gear 35 is small in relation to gear 36 so as to provide a drive reduction to the speed of gear 36 so as to slow the speed of the conveyor belt.

The brush 25 has a small gear 40 fixed to its outer end in front of the gear 38 in driving engagement with gear 38. Gear 38 is fixed to gear 37 and both gears are free to rotate on the front shaft 28′ of the conveyor belt. A chain 41 connects gears 34 and 37 and drives 37. Gear 38 is large in relation to gear 34 and large in relation to gear 40. Consequently, the rotation of the shaft 29 of the wheels provides an increased axial speed to the brush shaft 40 in relation to the shaft 29.

The front wall of the hopper has a fixed portion 42 which is fixed to the other three wall portion. The fixed portion 42 extends down with its lower edge spaced above the belt and a narrow wall portion 43 extends downward further toward the belt with its upper edge overlapping the fixed portion of the wall forming an opening 44. The narrow wall portion serves as a brush and is adjustable downward toward the belt by means of three levers 45, 46, and 47 so as to enable the operator to vary the amount of peat moss traveling out the opening 44 at the front of the hopper on the belt. The three levers are pivotally mounted between the fixed front wall portion 42 of the hopper and the narrow wall portion at the bottom of the fixed portion of the wall. Each lever has a knob 45′, 46′ and 47′ and rotating the knobs in one direction will loosen the levers and allow the levers to be pivoted about their pivot to cause that portion of the adjustable wall to be either raised or lowered. The pivoting of the levers in a clockwise direction, when viewed from FIG. 1, will lower the narrow wall portion 43 to reduce the size and ultimately close the opening 44, while pivoting the levers in a counter clockwise direction increase the size of the opening and ultimately fully open the opening.

In its operation, the hopper will be pushed along on a field, from left to right, as viewed from FIG. 3. This will cause the wheel to rotate on the ground clockwise when viewed from FIG. 3 which through the two gear connections to the font shaft of the belt will rotate the belt clockwise and through the three gear connection s with the brush will rotate the brush counter clockwise.

Consequently, the clockwise rotation of the belt will feed the moss in the hopper left to right out the opening 44 in the hopper against the brush and the brush, in rotating counterclockwise, will feed the moss downward between the front end of the belt and the brush onto the ground to thereby spread the moss onto the ground as the hopper apparatus is moved along the ground.

At the rear of the apparatus is a drag brush 48 which is pivotally mounted to pivot down about its pivot 49 to its downwardly inclined operative position as shown in FIGS. 2 and 3 to drag along the ground after the peat moss has been distributed out the front of the apparatus to assure that it is being evenly spread along the ground to ensure better use of the peat moss.

The handle 22 has also a pivotally mounted trailer hitch 50. The trailer hitch is pivotally mounted to the handle at pivot mount 51 and can be swung from an inactive position as shown in FIG. 1 and swung 180 degrees about its pivot to project rearwardly beyond the handle when serving as a trailer hitch and can be locked in either position by a pin 52. When the Mobile Seed Spreader is being transported from one operation to another, it will be towed in an opposite direction from its movement in a seed spreading operation. When being towed, it will be towed from right to left in the direction of the arrow as shown in FIG. 8 with the hitch projecting out in its operative position to be attached to the trailer hitch of a tow truck. The handle will be lowered from its inclined position as shown in FIGS. 1 and 2 to its horizontal position as shown in FIGS. 6 and 7 and the hitch will be pivoted to its operative position as shown in FIG. 7.

Also for towing, the drag brush 48 will be pivoted to its upward horizontal position about pivot 49 and locked in that horizontal position by a lever 53 so as to be away from the ground and not interfere with the towing of the apparatus in the opposite direction of its movement when being used.

It will be obvious that various changes and departures may be made to the invention without departing from the spirit and scope there of accordingly it is not intended that the invention be limited to the specifically described in the specification or as illustrated in the drawings but only as set forth in the appended claims wherein:

What is claimed is:

1. A mobile peat moss dispensing trailer for dispensing peat moss onto a golf course, said trailer having a main frame with a pair of wheels mounted on each lateral side of the frame, a hopper mounted upon the frame between the wheels forming a receptacle for receiving and retaining peat moss, said hopper having surrounding sides and an open bottom, a conveyor belt mounted across the open bottom of the hopper, several of the sides of the hopper being slanted inwardly at their upper ends to prevent peat moss from clinging on the sides so that the peat moss will tend to fall towards the bottom of the hopper, brush means rotatably mounted along the front bottom of the hopper in front of the opening in the bottom of the hopper, drive means driven by rotation of at least one of the wheels, said drive means in turn engagable to said conveyor belt and brush to cause said conveyor belt to rotate toward the front of the opening at the bottom of the hopper to convey peat moss in the hopper toward the brush, said brush being rotatably driven rearward and downward in its rotation toward the belt by said drive means to drive said peat moss driven forward by the conveyor belt downward off the front end of the belt so that the belt and brush will act in combination to feed peat moss leaving out the bottom front of the hopper opening onto the ground spread across the width of the hopper opening onto the golf course.

2. A mobile dispensing trailer for dispensing granular material onto the ground, said trailer having a main frame with a pair of wheels mounted on opposing lateral sides of the frame, a hopper mounted on the frame between the wheels forming a receptacle for receiving and retaining the granular material, said hopper having surrounding sides and an open bottom, a conveyor belt mounted across the open bottom of the hopper, brush means rotatably mounted across the bottom of the hopper in front of the conveyor belt and in front of the hopper opening, drive means driven by the rotation of at least one of the wheels of the trailer, said drive means in turn engagable to said conveyor belt and brush to cause said conveyor belt to rotate toward the front of the opening at the bottom of the hopper, said brush being rotatably driven rearward and downward by said drive means to drive the granular material driven forward by the conveyor belt downward off the front of the belt so that the belt and brush will act in combination to feed the granular material in the hopper to leave the hopper out the bottom front of the hopper opening spread at least substantially across the width of the hopper opening onto the ground.
